(19) United States
(12) Patent Application Publication
(10) Pub. No.: US 2003/0088723 A1
(43) Pub. Date: May 8, 2003

(54) System and method for processing interrupts

(76) Inventors: Richard P. Mackey, Phoenix, AZ (US); Mark A. Schmisseur, Phoenix, AZ (US); Timothy J. Jehl, Higley, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/007,472

(22) Filed: Nov. 8, 2001

(51) Int. Cl. G06F 13/24

(52) U.S. Cl. 710/260

(57) ABSTRACT

Disclosed are a system and method of processing interrupt messages received on a data bus from a plurality of interrupt sources. The interrupt message receiver comprises logic to initiate an interrupt signal on one or more interrupt signal inputs to a controller in response to receipt of an interrupt message. The controller may then service the interrupt message in response to the interrupt signal.

### BACKGROUND

1. Field

The subject matter disclosed herein relates to the processing of interrupts from interrupt sources. In particular, the subject matter disclosed herein relates to processing interrupts from multiple sources.

2. Information

Processing systems typically employ interrupt driven architectures whereby a controller or processor may respond to interrupt requests from one or more interrupt sources. The controller or processor may service the interrupt request by, for example, halting execution of a current task and commencing execution of an interrupt handler or interrupt service routine. Upon completion of servicing the interrupt request, the controller or processor may resume execution of the halted task or commence servicing a subsequent interrupt request.

Interrupt driven processing systems are typically adapted to service interrupt requests from multiple interrupt sources. As the number of interrupt sources providing interrupt requests to a controller or processor increases, so does the demand for servicing interrupt requests by the controller or processor also increases. Accordingly, there is a need for techniques to manage resources of a controller or processor to service the interrupt requests from the multiple interrupt sources.

### BRIEF DESCRIPTION OF THE FIGURES

Non-limiting and non-exhaustive embodiments of the present invention will be described with reference to the following figures, wherein like reference numerals refer to like parts throughout the various figures unless otherwise specified.

FIG. 1 shows a schematic diagram of a system to process interrupt messages from a plurality of interrupt sources according to an embodiment of the present invention.

FIGS. 2 and 3 illustrate an embodiment in which the interrupt controller may allocate interrupt servicing resources among a plurality of interrupt sources according to an embodiment of the system shown in FIG. 1.

### DETAILED DESCRIPTION

Reference throughout this specification to “one embodiment” or “an embodiment” means that a particular feature, structure, or characteristic described in connection with the embodiment is included in at least one embodiment of the present invention. Thus, the appearances of the phrase “in one embodiment” or “an embodiment” in various places throughout this specification are not necessarily all referring to the same embodiment. Furthermore, the particular features, structures, or characteristics may be combined in one or more embodiments.

“Machine-readable” instructions as referred to herein relates to expressions which may be understood by one or more machines for performing one or more logical operations. For example, machine-readable instructions may comprise instructions which are interpretable by a processor compiler for executing one or more operations based upon one or more data objects. However, this is merely an example of machine-readable instructions and embodiments of the present invention are not limited in this respect.

“Machine-readable medium” as referred to herein relates to media capable of maintaining expressions which are perceivable by one or more machines. For example, a machine readable medium may comprise one or more storage devices for storing machine-readable instructions. However, this is merely an example of a machine-readable medium and embodiments of the present invention are not limited in this respect.

“Logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Also, logic may comprise machine-executable instructions stored in a memory in combination with processing circuitry to execute such machine-readable instructions. However, these are merely examples of structures which may provide logic and embodiments of the present invention are not limited in these respects.

A “data bus” as referred to herein relates to circuitry for transmitting data between or among devices. A “bus transaction” as referred to herein relates to an interaction between devices coupled in a data bus structure wherein one device transmits data addressed to the other device through the bus structure. For example, such a bus transaction may comprise transmitting a message from a first device to a second device in a “write transaction” on a data bus coupled between the devices. However, these are merely examples of a data bus and bus transaction, and embodiments of the present invention are not limited in these respects.

A “bridge” as referred to herein relates to a device coupled between data busses to transmit data between devices coupled to one data bus and devices coupled to another data bus. According to an embodiment, a bridge may enable a first device coupled to a first data bus to address a bus transaction to a second device coupled to a second data bus coupled to the first data bus by the bridge. However, this is merely an example of a bridge and embodiments of the present invention are not limited in this respect.

An “interrupt signal” as referred to herein relates to a signal to inform a process that a certain event has occurred or condition exists. For example, a process may temporarily suspend execution of a task to take action to address the associated event or condition in response to the interrupt signal. However, this is merely an example of an interrupt signal and embodiments of the present invention are not limited in these respects.

A “controller” as referred to herein relates to logic to monitor or respond to events. A controller may comprise a processor which executes machine-readable instructions stored in a memory or hardwired logic. A controller may comprise one or more “interrupt signal inputs” to respond to interrupt signals. However, these are merely examples of a controller and embodiments of the present invention are not limited in this respect.

An “interrupt message” as referred to herein relates to a message comprising data related to an interrupt condition. Such an interrupt message may comprise data identifying a source of the interrupt message, or a type of interrupt condition or event. Also, such an interrupt message may be transmitted in a write transaction on a data bus addressed to a device which initiates interrupt signals on an interrupt signal input in response to interrupt messages. However, these are merely examples of an interrupt message and embodiments of the present invention are not limited in this respect.

An “interrupt source” as referred to herein relates to a process or device which detects an event or condition. For example, an interrupt source may comprise an input/output device and transmit an interrupt request in response to detection of an event or condition. However, this is merely an example of an interrupt source and embodiments of the present invention are not limited in this respect.

An “interrupt message receiver” as referred to herein relates to a device to initiate one or more interrupt signals on an interrupt signal input to a controller in response to interrupt messages received from one or more interrupt sources. An interrupt message receiver may comprise logic to initiate interrupt signals in response to bus transactions on a data bus. However, this is merely an example of an interrupt message receiver and embodiments of the present invention are not limited in this respect.

Briefly, an embodiment of the present invention relates to an interrupt message receiver which is responsive to interrupt messages received on a data bus from a plurality of interrupt sources. The interrupt message receiver comprises logic to initiate interrupt signals on one or more interrupt signal inputs to a controller in response to receipt of an interrupt message. However, this is merely an example embodiment and other embodiments of the present invention are not limited in these respects.

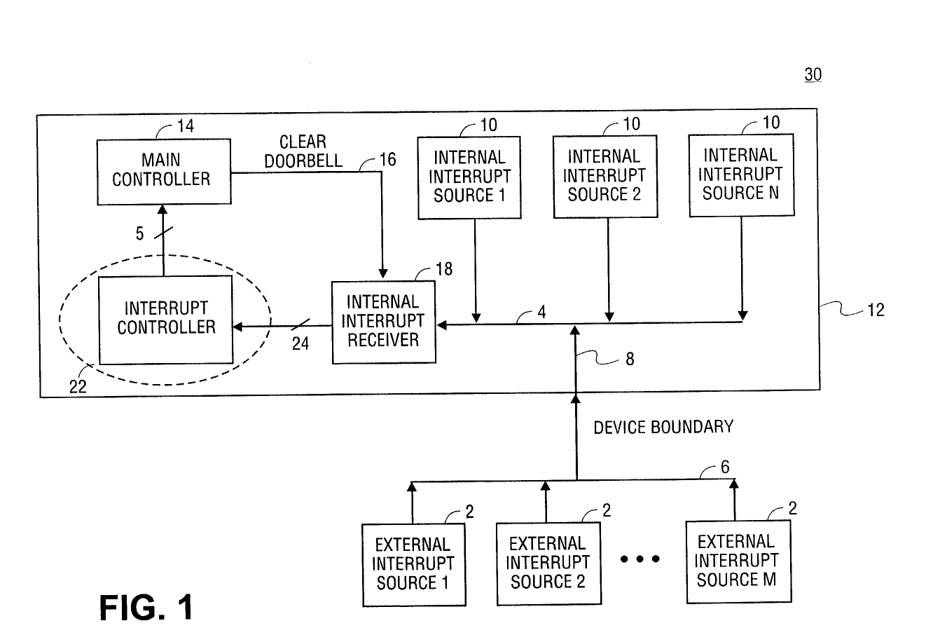

FIG. 1 shows a schematic diagram of a system 30 to process interrupt messages from a plurality of interrupt sources according to an embodiment of the present invention. In the illustrated embodiment, a main controller 14, interrupt message receiver 18 and internal interrupt sources 10 may be formed in a single semiconductor device 12. Also, a data bus 4 may couple the interrupt message receiver 18 and the internal interrupt sources 10 to enable data to be transmitted from the internal interrupt sources 10 to the interrupt message receiver 18 in bus transactions. For example, the data bus 4 may comprise a data bus formed according to the Peripheral Components Interconnect (PCI) Local Bus Specification Rev. 2.2, Dec. 18, 1998 (hereinafter the PCI Local Bus Specification) or a data bus formed according to PCI-X 1.0a. Accordingly, each internal interrupt source 10 may transmit an interrupt message to the interrupt message receiver 18 by initiating a write transaction on data bus 4 addressed to the interrupt message receiver 18. However, this is merely an example of a bus architecture which may be used for a data bus and embodiments of the present invention are not limited in this respect.

The interrupt message receiver 18 may also be coupled to a plurality external interrupt sources 2 at a device boundary with the device 12. The external interrupt sources 2 may coupled by a data bus 6 formed according to the PCI Local Bus Specification to enable transmission of data through bus transactions. However, this is merely an example architecture of a data bus to enable communication through bus transactions and embodiments of the present invention are not limited in this respect.

The data bus 6 may be coupled to the data bus 4 by a bridge 8 to enable external interrupt sources 2 to communicate with devices coupled to the data bus 4. In an embodiment in which the data buses 4 and 6 each comprise data buses formed according to the PCI Local Bus Specification, for example, the bridge 8 may be formed according to the PCI-to-PCI Bridge Architecture Specification, Rev. 1.1, Dec. 18, 1998 (hereinafter “PCI-to-PCI Bridge Specification”). Accordingly, the external interrupt sources 2 may transmit interrupt messages to the interrupt message receiver 18 by initiating write transactions on the data bus 6 which are addressed to the interrupt message receiver 18 coupled as a device on the data bus 4. However, this is merely an example of how external interrupt sources may be coupled to an interrupt message receiver on a data bus to transmit interrupt messages and embodiments of the present invention are not limited in this respect.

The main controller 14 may comprise logic to respond to interrupt signals received on one or more interrupt signal inputs 20. For example, the main controller 14 may comprise a processor to execute an interrupt service routine in response to receipt of an interrupt signal. However, this is merely an example of how a controller may respond to an interrupt signal and embodiments of the present invention are not limited in this respect. According to an embodiment, the main controller 14 may comprise any one of several processors capable of responding to interrupt signals including, for example, an ARM processor or i960® processor sold by Intel Corporation. In an embodiment in which the main controller 14 comprises an ARM processor, for example, the main controller 14 may respond to interrupt signals received on at least two interrupt signal inputs 20, one interrupt signal input to receive interrupt signals corresponding with an IRQ interrupt signal and one interrupt signal input to receive interrupt signals corresponding with an FIQ interrupt signal. However, these are merely examples of processors which are capable of responding to interrupt signals on one or more interrupt signal inputs and embodiments of the present invention are not limited in these respects.

In an alternative embodiment, the controller 14 may comprise more than one independently executing controller where each controller comprises at least one interrupt signal input 20 to receive interrupt signals initiated in response to interrupt messages received at the interrupt message receiver 18. However, this is merely an alternative embodiment and embodiments of the present invention are not limited in this respect.

According to an embodiment, the interrupt message receiver 18 may respond to an interrupt message received on the data bus 4 from one of the internal and external interrupt sources 2 and 10 by initiating an interrupt signal on an interrupt signal input 20. Upon receipt of an interrupt message from a particular interrupt source 2 or 10 (e.g., receipt of a write transaction on the data bus 4), the interrupt message receiver 18 may identify the particular interrupt source from data transmitted encapsulated in the write transaction and initiate an interrupt signal on an interrupt signal input 20 corresponding with the particular identified interrupt source. Alternatively, the interrupt message receiver 18 may receive write transactions at a range of addresses and identify the particular interrupt source from a destination address of the write transaction (in the range of addresses) associated with the particular interrupt source. Upon completion of servicing the interrupt, the main controller 14 may notify the interrupt message receiver 18 that the interrupt message from the interrupt source has been completed. However, this is merely an example of how an interrupt message receiver may initiate interrupt signals to a controller in response to receipt of interrupt messages and embodiments of the present invention are not limited in these respects.

According to an embodiment, each internal and external interrupt source 2 and 10 may be associated with a particular interrupt signal input 20 such that the interrupt message receiver 18 may initiate interrupt signals on the particular interrupt signal input 20 in response to interrupt messages from the interrupt source. In an embodiment in which the controller 14 is an ARM type processor, for example, some of the interrupt sources 2 and 10 may be allocated to an interrupt signal input 20 to respond to IRQ types of interrupts while other interrupt sources 2 and 10 may be allocated to another interrupt signal input 20 to respond to FIQ types of interrupts. However, this is merely an example of how interrupt sources may be allocated to interrupt signal inputs and embodiments of the present invention are not limited in this respect.

According to an embodiment, the interrupt message receiver 18 may maintain a doorbell register (not shown) comprising a bit for each of the internal and external interrupt sources 2 and 10. In response to receipt of an interrupt message from a particular interrupt source 2 or 10, the interrupt message receiver 18 may set a bit in the doorbell register corresponding with the particular interrupt source. The doorbell register may also be accessible to the main controller 14 to provide a clear signal 16 in response to completion of servicing an interrupt (e.g., from an interrupt signal received on an interrupt signal input 20).

In an alternative embodiment, an interrupt controller 22 may initiate interrupt signals to the main controller 14 on interrupt signal inputs 20 based upon bits 24 in the doorbell register. The interrupt controller 22 may associate each pending interrupt signal on an interrupt signal input 20 with a set bit in the doorbell register to determine an availability of the main controller 14 to service a subsequent interrupt signal on the interrupt signal input 20. Upon detecting that the bit in the doorbell register (corresponding with the previously transmitted interrupt signal on the interrupt signal input 20) has been cleared by the main controller 14, the interrupt controller 22 may initiate a subsequent interrupt signal on the interrupt signal input 20.

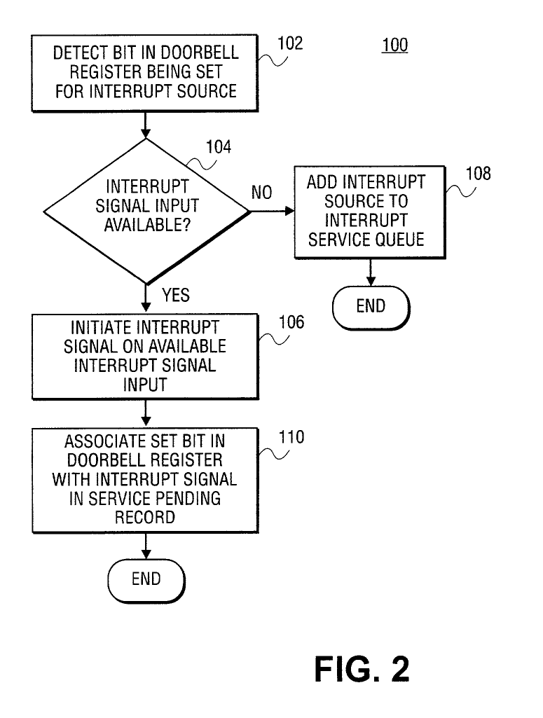

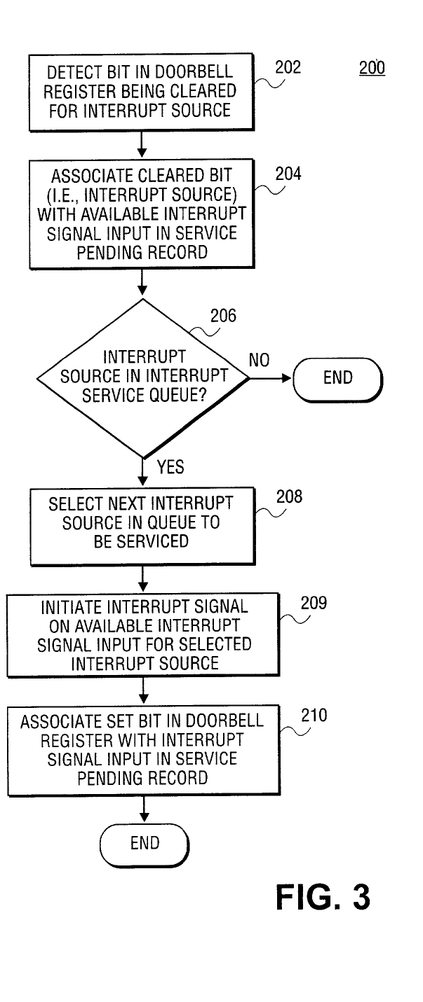

According to an embodiment, the interrupt controller 22 may comprise logic to allocate resources of the main controller 14 to service interrupt messages from among the internal and external interrupt sources 2 and 10. For example, the internal and external interrupt sources 2 and 10 may contend for a limited or constrained ability of the main controller 14 to service interrupt messages received at the interrupt message receiver 18. FIGS. 2 and 3 illustrate an embodiment in which the interrupt controller 22 may allocate interrupt servicing resources of the main controller 14 among the interrupt sources 2 and 10.

FIG. 2 shows a flow diagram illustrating logic to respond to detection of a bit being set in the doorbell register according to an embodiment of the interrupt controller 22 shown in FIG. 1. At block 102, the interrupt controller 22 may detect that the interrupt message receiver 18 has set a bit in the doorbell register (upon receipt of an interrupt message from an interrupt source). The interrupt controller 22 may maintain a “service pending record” to indicate which interrupt signal inputs 20 have received interrupt signals (e.g., from interrupt sources associated with the interrupt signal input 20) which have not yet been serviced by the main controller 14. At diamond 104, the interrupt controller 22 may determine whether an interrupt signal input 20 is available to receive an interrupt signal for servicing the interrupt message detected at block 102 based upon the service pending record (e.g., an interrupt signal input 20 that is not associated with an interrupt signal that has not been completely serviced by the main controller 14). If no interrupt signal input is available to service the interrupt message detected at block 102, the interrupt controller 22 may place the associated interrupt source on an interrupt service queue. If an interrupt signal input 20 is available to service the interrupt message detected at block 102, the interrupt controller 22 may initiate an interrupt signal on the inerrupt signal input 20 at block 106 and associate interrupt signal input with the set bit (in the doorbell register) in the service pending record.

FIG. 3 shows a flow diagram illustrating a process 200 for responding to a detection of a bit being cleared in a doorbell register according to an embodiment of the interrupt controller 22 illustrated in FIGS. 1 and 2. Upon detecting that the main controller 14 has cleared a bit in the doorbell register (in response to completion of an interrupt service for an interrupt source corresponding with the cleared bit) at block 202, the interrupt controller 22 may associate the cleared bit in the service pending record to identify the newly available interrupt signal input corresponding with the completed interrupt service at block 104. If there are interrupt sources in the interrupt service queue (e.g., enqueued in the interrupt service queue at block 108), the interrupt controller 22 may select the next interrupt source to service from the interrupt service queue at block 208. The interrupt controller may then initiate an interrupt signal on the available interrupt signal input for the selected interrupt source (block 209) and associate the set bit in the doorbell register with the interrupt signal input in the service pending record (block 210).

At block 208, the interrupt controller 22 may use any one of several schemes to select the next interrupt source to service from interrupt service queue. The interrupt controller 22 may implement scheme that selects interrupt sources from the interrupt service queue based upon an a priori priority. For example, the interrupt controller 22 may select to service interrupt messages from all internal interrupt sources 10 in the interrupt service queue before servicing interrupt messages from any external interrupt source 2. Alternatively, the interrupt controller 22 may prioritize the servicing of interrupt message according to other schemes such as a round-robin or least recently serviced schemes. However, these are merely examples for prioritizing the servicing of interrupt messages from a plurality of interrupt sources and embodiments of the present invention are not limited in these respects.

According to an embodiment, the interrupt controller 22 may maintain a separate interrupt service queue for each of the interrupt signal inputs 20. For example, each of the interrupt sources 2 and 10 may be allocated to an interrupt signal input 20 to service interrupt conditions at the interrupt source. Accordingly, in response to detecting a bit for a particular interrupt source being set in the doorbell register at block 102, the interrupt controller 22 may determine the availability of the interrupt signal input 20 allocated to the interrupt source at block 104 and add the interrupt source to the interrupt service queue associated with the interrupt signal input at block 108 (FIG. 2). Also, in response to a bit corresponding with an interrupt source being cleared (in the doorbell register), the interrupt controller 22 at diamond 206 may examine an interrupt service queue associated with an interrupt signal input 20 allocated to the interrupt source (corresponding with the cleared bit) and select the next interrupt source to be serviced by the interrupt signal input from the associated interrupt service queue at block 208.

While there has been illustrated and described what are presently considered to be example embodiments of the present invention, it will be understood by those skilled in the art that various other modifications may be made, and equivalents may be substituted, without departing from the true scope of the invention. Additionally, many modifications may be made to adapt a particular situation to the teachings of the present invention without departing from the central inventive concept described herein. Therefore, it is intended that the present invention not be limited to the particular embodiments disclosed, but that the invention include all embodiments falling within the scope of the appended claims.

What is claimed is:

1. A system comprising:
a controller responsive to interrupt signals received on one or more interrupt signal inputs;
an interrupt message receiver coupled to the one or more interrupt signal inputs; and
a plurality of interrupt sources to transmit interrupt messages to the interrupt message receiver through a data bus,
wherein the interrupt message receiver further comprises logic to initiate interrupt signals on the one or more interrupt signal inputs in response to receipt of interrupt messages from the data bus.

2. The system of claim 1, wherein the interrupt message receiver comprises logic to decode each interrupt message in response to receipt of one or more write transactions received from the data bus.

3. The system of claim 1, wherein the system further comprises a register of bits, each interrupt source corresponding with one bit, and wherein the interrupt message receiver comprises logic to set a bit in response to receipt of an interrupt message from an interrupt source corresponding with the bit and wherein the controller comprises logic to clear the bit in response to completion of servicing an interrupt associated with the interrupt message.

4. The system of claim 1, wherein the controller comprises a first interrupt signal input to receive an IRQ interrupt signal and a second interrupt signal input to receive a FIQ interrupt signal.

5. The system of claim 1, wherein controller comprises logic to service interrupts in response to interrupt signals received on the one or more interrupt signal inputs the system further comprises an interrupt controller comprising:
logic to maintain a record of at least one unserviced interrupt message received at the interrupt message receiver from an interrupt source; and
logic to initiate an interrupt signal on an interrupt signal input in to service the unserviced interrupt message in response to completion of an interrupt service by the controller.

6. The system of claim 5, wherein the interrupt controller further comprises:
logic to define a priority for one or more interrupt sources;
logic to maintain a queue of unserviced interrupt messages based upon the priority; and
logic to select an unserviced interrupt message from the queue in response to completion of an interrupt service by the controller.

7. The system of claim 5, wherein the interrupt controller further comprises a plurality of interrupt signal inputs and the interrupt controller further comprises:
logic to associate each interrupt source with an interrupt signal input;
logic to maintain a queue of unserviced interrupt messages for each interrupt signal input, each unserviced interrupt messages being received from an interrupt source associated with the interrupt signal input; and
logic to select an unserviced interrupt message from a queue in response to completion of an interrupt service initiated at the interrupt signal input associated with the queue.

8. The system of claim 1, wherein the system comprises a plurality of controllers, each controller comprising one or more interrupt signal inputs, and wherein the interrupt message receiver is coupled to each interrupt signal input of the controllers.

9. A method comprising:
receiving interrupt messages on a data bus from a plurality of interrupt sources; and
selectively initiating interrupt signals to a controller on one or more interrupt signal inputs in response to each received interrupt message.

10. The method of claim 9, wherein the method further comprises decoding each received interrupt message in response to receipt of one or more write transactions received from the data bus.

11. The method of claim 9, wherein the method further comprises:
setting a bit in a register of bits in response to receipt of an interrupt message from an interrupt source corresponding with the bit, each interrupt source corresponding with one bit in the register; and
clearing the bit in response to completion of servicing an interrupt associated with the interrupt message.

12. The method of claim 9, wherein the method further comprises selectively initiating interrupt signals to a controller on a first interrupt signal input corresponding with an IRQ interrupt signal and on a second interrupt signal input corresponding with a FIQ interrupt signal.

13. The method of claim 9, wherein method further comprises:
maintaining a record of at least one unserviced interrupt message received at the interrupt message receiver from an interrupt source; and
initiating an interrupt signal on an interrupt signal input to service the unserviced interrupt message in response to completion of an interrupt service by the controller.

14. The method of claim 9, the method further comprising:
defining a priority for one or more interrupt sources;
maintaining a queue of unserviced interrupt messages based upon the priority; and
selecting an unserviced interrupt message from the queue in response to completion of an interrupt service by the controller.

15. The method of claim 14, wherein the method further comprises: associating each interrupt source of with one of a plurality of interrupt signal inputs;
maintaining a queue of unserviced interrupt messages for each interrupt signal input, each unserviced interrupt messages being received from an interrupt source associated with the interrupt signal input; and
selecting an unserviced interrupt message from a queue in response to completion of an interrupt service initiated at the interrupt signal input associated with the queue.

16. An interrupt message receiver comprising:
an interface to a data bus to receive interrupt messages from a plurality of interrupt sources; and
logic to initiate interrupt signals to a controller on interrupt signal inputs in response to receipt of the interrupt messages.

17. The interrupt message receiver of claim 16, wherein the interrupt message receiver comprises logic to decode each interrupt message in response to receipt of one or more write transactions received from the data bus.

18. The interrupt message receiver of claim 16, wherein the interrupt message receiver further comprises:
logic to set a bit in a register of bits in response to receipt of an interrupt message from an interrupt source corresponding with the bit; and
logic to clear the bit in response to completion of servicing an interrupt associated with the interrupt message.

19. The interrupt message receiver of claim 16, the interrupt message receiver further comprising:
logic to transmit interrupt signals on a first interrupt signal input to provide an IRQ interrupt signal; and
logic to transmit interrupt signals on a second interrupt signal input to provide an FIQ interrupt signal.

20. The interrupt message receiver of claim 16, wherein the interrupt message receiver further comprises an interrupt controller comprising:
logic to maintain a record of at least one unserviced interrupt message received from an interrupt source; and
logic to initiate an interrupt signal on an interrupt input signal to service the unserviced interrupt message in response to completion of an interrupt service.

21. The interrupt message receiver of claim 20, wherein the interrupt controller further comprises:
logic to define a priority for one or more interrupt sources;
logic to maintain a queue of unserviced interrupt messages based upon the priority; and
logic to select an unserviced interrupt message from the queue in response to completion of an interrupt service.

22. The interrupt message receiver of claim 20, wherein the interrupt controller further comprises:
logic to associate each interrupt source with an interrupt signal input;
logic to maintain a queue of unserviced interrupt messages for each interrupt signal input, each unserviced interrupt messages being received from an interrupt source associated with the interrupt signal input; and
logic to select an unserviced interrupt message from a queue in response to completion of an interrupt service initiated at the interrupt signal input associated with the queue.

23. An apparatus comprising:
means for receiving interrupt messages on a data bus from a plurality of interrupt sources; and
means for selectively initiating interrupt signals to a controller on one or more interrupt signal inputs in response to each received interrupt message.

24. The apparatus of claim 23, wherein the apparatus further comprises means for decoding each received interrupt message in response to receipt of one or more write transactions received from the data bus.

25. The apparatus of claim 23, wherein the apparatus further comprises:
means for setting a bit in a register of bits in response to receipt of an interrupt message from an interrupt source corresponding with the bit, each interrupt source corresponding with one bit in the register; and
means for clearing the bit in response to completion of servicing an interrupt associated with the interrupt message.

26. The apparatus of claim 23, wherein the apparatus further comprises means for selectively initiating interrupt signals to a controller on a first interrupt signal input corresponding with an IRQ interrupt signal and on a second interrupt signal input corresponding with a FIQ interrupt signal.

27. The apparatus of claim 23, wherein apparatus further comprises:
means for maintaining a record of at least one unserviced interrupt message received at the interrupt message receiver from an interrupt source; and
means for initiating an interrupt signal on an interrupt signal input to service the unserviced interrupt message in response to completion of an interrupt service by the controller.

28. The apparatus of claim 23, the apparatus further comprising:
means for defining a priority for one or more interrupt sources;
means for maintaining a queue of unserviced interrupt messages based upon the priority; and
means for selecting an unserviced interrupt message from the queue in response to completion of an interrupt service by the controller.

29. The apparatus of claim 28, wherein the apparatus further comprises:
means for associating each interrupt source of with one of a plurality of interrupt signal inputs;
means for maintaining a queue of unserviced interrupt messages for each interrupt signal input, each unserviced interrupt messages being received from an interrupt source associated with the interrupt signal input; and
means for selecting an unserviced interrupt message from a queue in response to completion of an interrupt service initiated at the interrupt signal input associated with the queue.
